(19) United States
(12) Patent Application Publication
(10) Pub. No.: US 2014/0346862 A1
(43) Pub. Date: Nov. 27, 2014

(54) MOTOR VEHICLE

(71) Applicant: Audi AG, Ingolstadt (DE)

(72) Inventor: Josef Winkler, Kipfenberg (DE)

(21) Appl. No.: 14/365,460

(22) PCT Filed: Aug. 1, 2012
(86) PCT No.: PCT/EP2012/003267

§ 371 Date: Jul. 29, 2014

(30) Foreign Application Priority Data
Dec. 16, 2011 (DE) 10 2011 121 486.4

(51) Int. Cl. B60L 11/18; H02J 7/00

(52) U.S. Cl. CPC B60L 11/1814; H02J 7/0052
USPC 307/9.1; 320/137

(57) ABSTRACT

A motor vehicle includes an electric machine that can be connected or is connected to a rechargeable energy storage device for supplying electric energy by way of an intermediate power inverter. The energy storage device can be connected via a motor-vehicle-side charge connection element to an external energy supply device which makes available electric energy. The charge connection element has at least one device for generating a three-phase current from a single-phase or two-phase alternating current, wherein the device includes a circuit arrangement with at least one capacitor that is connected in parallel with at least one three-phase current winding.

The invention relates to a motor vehicle, with at least one electric machine, which is connected or can be connected with at least one rechargeable energy storage device for electric energy with the interposition of at least one inverter, wherein the energy storage device can be connected via a motor-vehicle-side charging connector element with an external power supply device providing electric energy.

It is known to drive motor vehicles completely or partially, i.e. in addition to conventional internal combustion engines, by way of electric machines and/or electric motors. The electric energy required for operating the electric machine is usually provided by a rechargeable energy storage device implemented as a battery.

It has been proposed in this context to remove separate charging devices typically constructed as inverters and used for charging the rechargeable energy storage device, and to rely, when charging the rechargeable energy storage device, on the power electronics generally available on the motor-vehicle-side, i.e. in particular inverters connected between the electric machine and a corresponding rechargeable energy storage device. Thus, inverters generally already present in onboard networks of motor vehicles are used here in a dual role by supplying, on the one hand, the AC voltage necessary for the operation of the electric machine by suitable transformation of the DC voltage taken from the energy storage device; on the other hand, the inverters can be connected directly to an external power supply system, in particular a power grid, wherein the inverters convert the voltage provided by the power supply system into an appropriate voltage for the charging the motor-vehicle-side energy storage device.

Problems may occur when three-phase alternating current required for the operation of corresponding electric machines cannot be provided by the external power supply device, for example in situations where only a single-phase or a two-phase alternating current can be provided by the energy supply device. For these situations, special devices have been proposed which are designed to generate a three-phase alternating current from a single-phase or two-phase alternating current. However, such devices typically have complex circuit arrangement and include a variety of different power electronics components.

The invention is addresses the problem to provide a motor vehicle with an improved device for generating a three-phase alternating current from a single-phase or two-phase alternating current.

The problem is solved according to the invention by a motor vehicle of the aforementioned type, which is characterized in that the charging terminal of the motor vehicle has at least one device for generating a three-phase alternating current from a single-phase or two-phase alternating current, wherein the device includes at feast one circuit arrangement having at least one capacitor connected in parallel with at least one three-phase alternating current winding.

The at least one rechargeable energy storage device associated with the motor vehicle according to the invention, which can be described as a battery or a traction battery, can then also be charged from external power supply devices (power grids) that supply only a single-phase or two-phase AC voltage or AC current. For this purpose, a device for generating a three-phase alternating current from a single-phase or two-phase alternating current is associated with the charging connector element provided for connecting the motor vehicle with the power supply device, wherein the motor vehicle can usually be connected to the power supply device by way of a charging cable and the like. The device has a particularly simple design and includes or is constructed as at least one circuit arrangement having at least one capacitor connected in parallel with at least one three-phase alternating current winding.

The circuit arrangement is designed in particular as a Steinmetz circuit. Steinmetz circuits usually have at least one capacitor connected in parallel with at least one three-phase alternating current winding. Steinmetz circuits make it possible to operate electrical components, which typically require three-phase alternating currents, also with single-phase or two-phase alternating currents without requiring additional circuit arrangement. In relation to the motor vehicle of the present invention, the associated rechargeable energy storage device can hence be charged also with single-phase or a two-phase alternating currents. The Steinmetz circuit associated with the charging terminal element hereby converts the single-phase or two-phase alternating currents (multi-phase alternating currents) into a three-phase alternating current, wherein the three-phase alternating current is supplied to the energy storage device via the in particular three-phase inverter.

To prevent the electric machine and the electric motor of the motor vehicle, respectively, from transmitting a torque or other forces to the downstream drive train of the motor vehicle when a charging current or a charging voltage, respectively, is applied to the charging connector element, a disconnect device is advantageously provided which can be used to disconnect the connection between the at least one electric machine and the motor-vehicle-side drive train or the inverter.

A suitable disconnect device may be constructed, for example, as at least one electrical switching device, wherein the electric machine can be disconnected from the inverter by the at least one an electrical switching device. Preferably, each of the three phases of the electric machine may be disconnected from the inverter by a separate electrical switching device, meaning that each phase of the electric machine can be disconnected or separated from the inverter by a separate switching device. The electric switching device can in particular be controlled by a suitable control device disposed on the vehicle so that the electric machine can be disconnected from the onboard power supply system, while the energy storage device is being charged, by opening the electric switching device which substantially serves as a switch. The energy supplied by the external power supply device supplied and flowing through the device, or the electric current supplied by the external power supply device and flowing through the device, is incapable of setting the electric machine in motion or to drive the electric machine.

Advantageously, in the aforementioned embodiment, at least one electrical resistance element, in particular an inductive resistance element, is connected downstream of the load connection element. The electrical resistance element is used to set a suitable voltage and/or current matched to the onboard electrical system of the motor vehicle. The electrical resistance of the electrical resistance element is hence matched to the onboard electrical system of the motor vehicle. Advantageously, at least one dedicated resistance element is associated with each line originating from the charging connector element, i.e. a suitable inductive resistive element is advantageously connected in each corresponding line.

The disconnect device or another disconnect device may in particular be also configured as a clutch, wherein the electric machine can be disconnected from the drive train of the motor vehicle via the clutch. The clutch is connected downstream of the electric machine such that, by opening the clutch, torques produced by a current flow and a rotation of the rotor while the energy storage device is being charged when the electric machine is not reliably electrically disconnected from the onboard network of the motor vehicle are not transferred to the additional drive shaft, i.e. a transmission, and more particularly to the drive axle or the drive wheels of the vehicle. The motor vehicle is then not at risk to move or start moving when the energy storage device connected to the external power supply device is being charged.

In an advantageous embodiment of the invention, the charging connector element may include at least one electrical switching device which can be used to disconnect the charging connector element from the onboard electrical system of the motor vehicle. Thus, the charging connector element can be electrically disconnected from the electrical system of the motor vehicle so that a voltage is no longer applied and the risk of injury to an operator or damage to other components is prevented. A central safety switch is here sufficient, so that the charging connector element can be disconnected from the electrical system of the motor vehicle without added circuit complexity. The respective electrical switching device(s) is/are controlled in particular by a control device that controls charging of the energy storage device.

The motor vehicle according to the invention can be designed as an all-electric vehicle or as a hybrid vehicle. The first alternative thus relates to a motor vehicle configured entirely without a combustion engine, whereas the second alternative relates to a motor vehicle that includes both an internal combustion engine and an electric machine that at least partially or temporarily operates as a drive unit, i.e. a motor vehicle having an electric motor. In particular, the hybrid vehicle may also be designed as a so-called plug-in hybrid vehicle, which differs from conventional hybrid vehicles in that the rechargeable energy storage device associated with the electric machine can be charged via an external power supply device.

In addition, the invention relates to a method for charging a motor vehicle, in particular a motor vehicle of the type described above. The motor vehicle has at least one electric machine, which can be or is connected with at least one motor-vehicle-side rechargeable energy storage device for electric energy via at least one interconnected inverter, wherein the energy storage device is connected to an external energy supply device providing electric energy for charging via a motor-vehicle-side charging connector element, wherein the charging connector element has at least one device for generating a three-phase alternating current from a single-phase or a two-phase alternating current and the energy storage device is hence charged with a single-phase or a two-phase alternating current. The employed device is characterized by at least one circuit arrangement having at least one capacitor connected in parallel with at least one three-phase alternating current winding. The circuit arrangement is constructed in particular as a Steinmetz circuit. In principle, all discussions relating to the motor vehicle according to the invention also apply to the method according to the invention.

In an advantageous embodiment of the method according to the invention, the electric machine may be brought to a predeterminable or predetermined minimum rotation speed before starting to charge the energy storage device, wherein charging of the energy storage device begins only when the electric machine has reached the predeterminable or predetermined minimum rotation speed. The turn-on current when charging begins can thus be reduced. When the minimum rotation speed which substantially depends on the power and the type of the electric machine is reached, the motor operation of the electric machine is switched off and the charging operation of the energy storage device is carried out. The amount of energy required to drive the electric machine to the required minimum rotation speed is supplied in particular by the additional energy storage device to be charged, so that a complete discharge of the energy storage device is not contemplated in this embodiment of the invention.

Additional advantages, features and details of the invention will become apparent from the exemplary embodiments described hereinafter and with reference to the drawings, wherein:

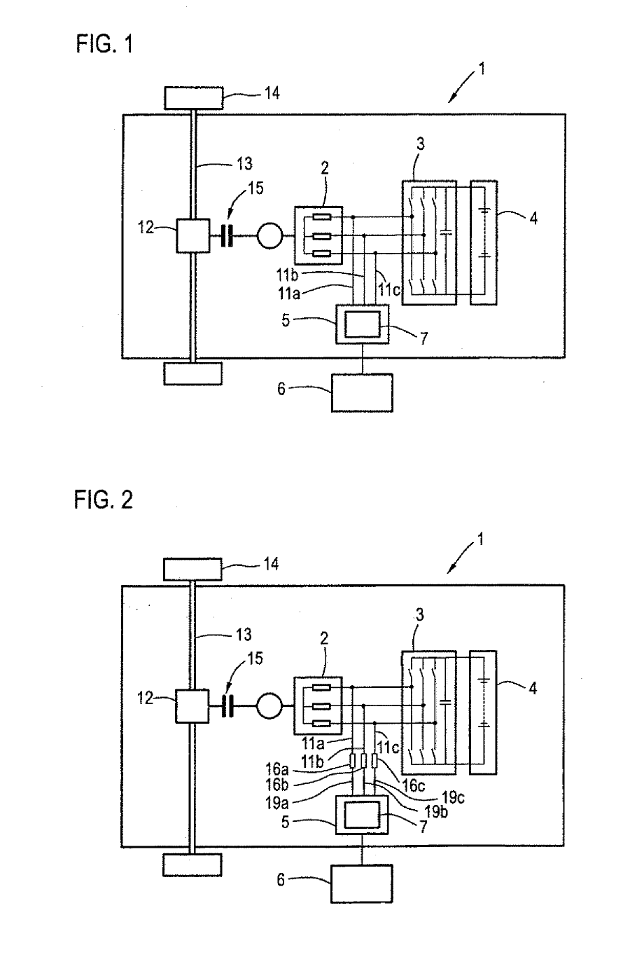

FIGS. 1-4 each show schematic diagrams of exemplary embodiments of a motor vehicle according to the present invention; and

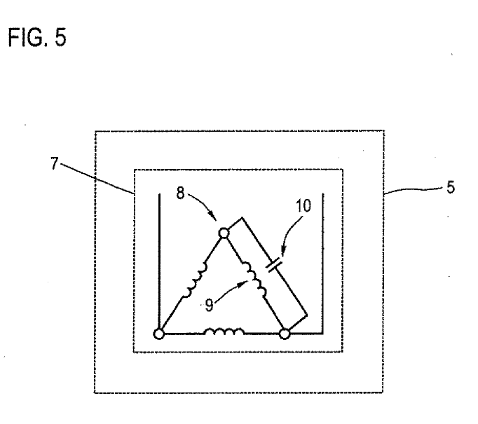

FIG. 5 illustrates a schematic diagram of the structure of a Steinmetz circuit.

FIG. 1 shows a schematic diagram of a motor vehicle 1 according to an exemplary embodiment of the invention. The motor vehicle 1 is formed as an all-electric vehicle, and is driven by an electric machine or a three-phase electric motor 2, respectively, serving as a primary drive unit. The electric motor 2 is connected to a rechargeable energy storage device 4, also referred to as battery or traction battery, by an interconnected three-phase inverter 3. The inverter 3 has customary, unspecified power electronic components, i.e. the inverter 3 includes, in particular, three parallel branches, each having two series-connected electrical switching elements. A similarly unspecified capacitor is connected in parallel with the three branches.

The energy storage device 4 can be connected or is connected in FIG. 1 via a motor-vehicle-side charging connector element 5 with an external power supply device 6 supplying electric energy, i.e. a power grid. The connection is established via one or more charging cables or the like. Consequently, the inverter 3 in conjunction with the charging connector element 5 is used as a charging device for the energy storage device 4, thereby obviating the need for additional charging devices, with the advantage of, for example, reducing weight and costs of the motor vehicle 1.

The charging connector element 5 has a device 7 for generating a three-phase alternating current from a single-phase or a two-phase alternating current (multi-phase alternating current). The device 7 includes a circuit arrangement 8 constructed as a Steinmetz circuit, which is shown in more detail in FIG. 5 that shows a schematic diagram of the structure of a Steinmetz circuit. As can be seen in FIG. 5, the device 7 thus includes the circuit arrangement 8 that includes a capacitor 10 connected in parallel with at least three-phase alternating current winding 9.

The energy storage device 4 can thus be charged from a power supply device 6 supplying only a single-phase or a two-phase alternating current, since the device 7, i.e. the circuit arrangement 8 designed as a Steinmetz circuit, transforms the single-phase or two-phase alternating current into a three-phase alternating current required for operating the electric motor 2. Three lines 11a-11c provided for the three different phases of the three-phase alternating current originate from the charging connector element 5 and are connected to corresponding terminals of the three-phase inverter 3.

As can be seen, the charging connector element 5 can be disconnected from the fines 11a-11c by way of corresponding electrical switching devices 19a-19c, so that current can flow through the charging connector element 5 only in conjunction with charging operations of the energy storage device 4, i.e. only when connected to an energy supply device 6. In all other situations, no voltage is present at the charging connector element 5, thereby reducing or preventing the risk of injury and/or damage to other components. The switching devices 19a-19c can also be combined into a common central switching element.

The connection of the electric motor 2 to the drive train on the downstream-side of the motor vehicle, i.e. in particular the transmission 12 and the drive axles 3 and/or the drive wheels 14, can be disconnected by a disconnect device in the form of an in particular mechanical clutch 15. The electric motor 2 can thus be mechanically decoupled from the drive train of the motor vehicle 1 while the energy storage device 4 is being charged, so that the currents induced in the electric motor 2 while the energy storage device 4 is being charged, which can result in rotation movements of the rotor associated with the electric motor 2 and thus generate of a torque, do not start the motor vehicle 1.

FIG. 2 shows a schematic diagram of another exemplary embodiment of a motor vehicle 1 according to the invention. The main difference from the motor vehicle 1 shown in FIG. 1 is that electrical resistance elements in the form of inductances 16a are connected in the lines 11a-16c originating from the charging connector element 5. The inductive resistors 16a-16c are especially matched to the voltage of the onboard electrical system of the motor vehicle 1.

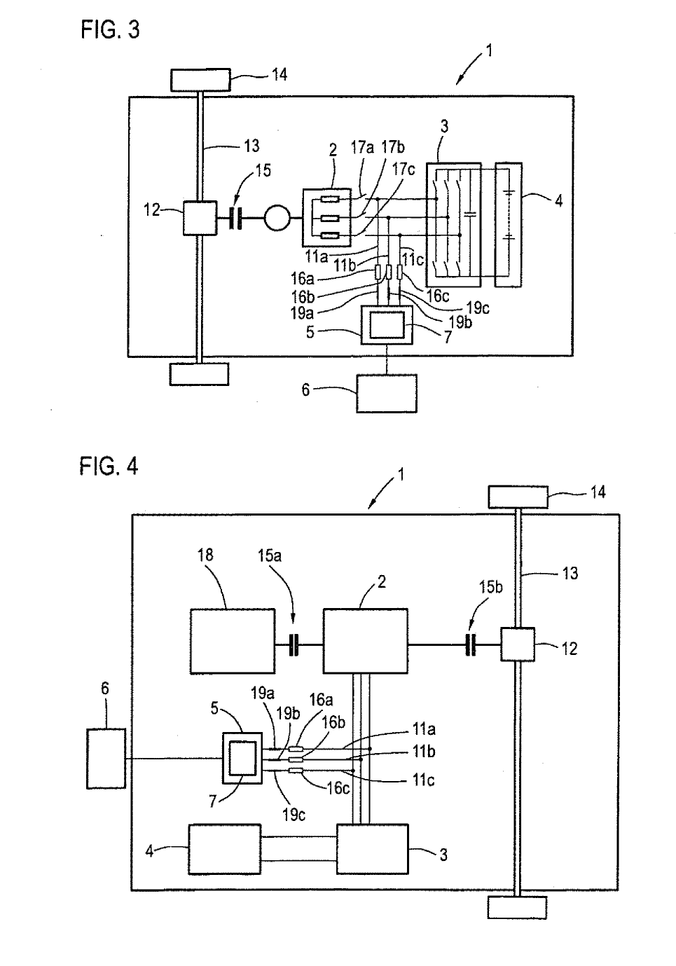

FIG. 3 shows a schematic diagram of another exemplary embodiment of a motor vehicle 1 according to the invention. The main difference from the embodiments illustrated in FIGS. 1, 2 is that the disconnect device is here not constructed as a clutch 15, but as an electrical switching device 17a-17c. It is evident that the electric motor 2 can be electrically disconnected from the inverter 3 and/or the energy storage device 4 and, optionally, the additional onboard electrical system of the motor vehicle 1 by way of suitable interconnected electrical switching devices 17a-17c in the electrical connection between the electric motor 2 and the inverter 3. Suitable control, i.e. opening the electric switching devices 17a-17c while the energy storage device 4 is being charged, can prevent induction of currents in the electric motor 2 during charging of the energy storage device 4, which could cause the motor vehicle 1 to start moving.

The electrical switching devices 17a-17c can be controlled by an (unillustrated) controller that monitors in particular charging of the energy storage device 4. In FIG. 3, like in FIG. 2, corresponding resistance elements in the form of inductive resistors 16a-16c are connected in the lines 11a-11c originating from the charging connector element 5. The embodiment shown in FIG. 3 therefore does not require a clutch 15, in particular mechanical clutch, of the type illustrated in FIGS. 1, 2.

FIG. 4 shows in a schematic diagram another exemplary embodiment of a motor vehicle 1 according to the invention. Unlike the embodiments shown in FIGS. 1-3, this embodiment is not an all-electric vehicle, but a hybrid motor vehicle in the form of a so-called plug-in hybrid motor vehicle. The motor vehicle 1 has therefore an internal combustion engine 18 in addition to the electric motor 2. As can be seen, the electric motor 2 can be disconnected from the internal combustion engine 18 by a clutch 15a. Similarly, the electric motor 2 can be disconnected from the transmission 12 of the motor vehicle 1 by a clutch 15b. The clutches 15a, 15b are normally provided in plug-in hybrid motor vehicles, so that in particular the clutch 15b arranged between the electric motor 2 and the transmission 12 can be used as a disconnect device according to the present invention. In other words, the electric motor 2 can be mechanically disconnected from both the transmission 12 and the internal combustion engine 18 while the energy storage device 4 associated with the electric motor 2 is being charged, thereby preventing currents induced in the electric motor 2 during charging of the energy storage device 4 and resulting rotation movements of the rotor associated with the electric motor 2 from causing the motor vehicle 1 to start moving.

Regardless of the concrete embodiments of motor vehicles 1 according to the invention shown in FIGS. 1-4, in the context of charging a motor vehicle 1 according to the invention, the electric motor 2 can advantageously be brought to a predeterminable or predetermined minimum speed before charging of the energy storage device 4 begins, so that charging of the energy storage device 4 begins only when the electric motor 2 has reached the predeterminable or predetermined minimum speed. Turn-on currents at the start of charging the energy storage device 4 can thus be reduced. As soon as the electric motor 2 has reached the predeterminable or predetermined minimum speed, the motor operation can be switched off and charging of the energy storage device 4 can begin.

The amount of energy required to drive the electric motor 2, i.e. the amount of energy required to bring the electric motor 2 to the predeterminable or predetermined minimum rotational speed can be supplied, for example, by the residual amount of energy still remaining in the energy storage device 4. In the example of the plug-in hybrid motor vehicle shown in FIG. 4, the electric motor 2 can also be driven to the predeterminable or predetermined minimum speed at least partly by the internal combustion engine 18.

1.-10. (canceled)

11. A motor vehicle comprising:
at least one electric machine,
at least one rechargeable energy storage device supplying electric energy to the at least one electric machine,
at least one inverter connected between the at least one electric machine and the at least one rechargeable energy storage device,
a vehicle-side charging connector element for connecting the at least one rechargeable energy storage device to an external energy supply device supplying electric energy,
wherein the charging connector element comprises at least one device for generating a three-phase alternating current from a single-phase or a two-phase alternating current, said at least one device comprising at least one circuit arrangement having at least one capacitor connected in parallel with at least one three-phase alternating current winding.

12. The motor vehicle of claim 11, wherein the circuit arrangement is formed as a Steinmetz circuit.

13. The motor vehicle of claim 11, further comprising at least one disconnect device configured to disconnect the at least one electric machine from a motor-vehicle-side drive train or the at least one inverter.

14. The motor vehicle of claim 13, wherein the disconnect device is constructed as at least one electric switching device and configured to disconnect the at least one electric machine from the at least one inverter.

15. The motor vehicle of claim 14, further comprising at least one electrical resistance element connected downstream of the charging connector element.

16. The motor vehicle of claim 15, wherein the at least one electrical resistance element is an inductive resistance element.

17. The motor vehicle of claim 13, wherein the disconnect device is constructed as a clutch configured to disconnect the at least one electric machine from the motor-vehicle-side drive train.

18. The motor vehicle of claim 11, wherein the charging connector element comprises at least one electric switching device configured to disconnect the charging connector element from an onboard electrical system of the motor vehicle.

19. The motor vehicle of claim 11, wherein the motor vehicle is constructed as an all-electric motor vehicle or as a hybrid motor vehicle.

20. A method for charging a motor vehicle with at least one electric machine connected via at least one inverter with at least one motor-vehicle-side rechargeable energy storage device, the method comprising
connecting the at least one energy storage device by way of a motor-vehicle-side charging connector element to an external energy supply device supplying single-phase or two-phase alternating current electric power,
generating with at least one device disposed in the charging connector element a three-phase alternating current from the supplied single-phase or two-phase alternating current, and
charging the at least one energy storage device with the generated three-phase alternating current,
wherein the at least one device disposed in the charging connector element comprises at least one circuit arrangement having at least one capacitor connected in parallel with at least one three-phase alternating current winding.

21. The method of claim 20, further comprising
bringing the at least one electric machine to a predetermined minimum rotational speed before beginning to charge the at least one energy storage device, and
charging the at least one energy storage device only when the at least one electric machine has reached the predetermined minimum rotational speed.
